(19) United States
(12) Patent Application Publication
(10) Pub. No.: US 2014/0160097 A1
(43) Pub. Date: Jun. 12, 2014

(54) DISPLAY MODULE CHIPSET INCLUDING SENSOR INTERFACE AND DISPLAY DEVICE HAVING THE DISPLAY MODULE CHIPSET

(71) Applicant: Samsung Electronics Co., Ltd., Suwon-Si (KR)

(72) Inventors: Myung Koo KANG, Seoul (KR); Jae Woo JUNG, Cheonan-si (KR); Young Wook HA, Seoul (KR)

(73) Assignee: SAMSUNG ELECTRONICS CO., LTD., Suwon-Si (KR)

(21) Appl. No.: 14/073,995

(22) Filed: Nov. 7, 2013

(30) Foreign Application Priority Data
Dec. 12, 2012 (KR) 10-2012-0144314

(51) Int. Cl. G06F 1/04; G09G 3/20

(52) U.S. Cl. CPC G06F 1/04; G09G 3/20
USPC 345/204; 713/600

(57) ABSTRACT

A timing controller includes a timing generation circuit configured to generate a plurality of timing control signals to control timing of image data displayed on a flat display panel, in response to a plurality of control signals, and a command generation circuit configured to analyze a sensing signal output by at least one sensor and generate a command associated with processing of the image data based on a result of the analysis. The command generation circuit may be built within a data driver or may be implemented by using a separate dedicated chip.

### CROSS-REFERENCE TO RELATED APPLICATIONS

This application claims priority under 35 U.S.C. §119(a) from Korean Patent Application No. 10-2012-0144314 filed on Dec. 12, 2012, the disclosure of which is hereby incorporated by reference in its entirety.

### BACKGROUND

Example embodiments relate to a sensor interface, a display module chipset including a sensor interface and a display device including the display module chipset.

In the fields of recent mobile devices, such as smart phones or tablet PCs, and home appliances such as smart TVs, many efforts have been devoted to reinforce user experience using an input/output device These efforts include enhancing control by a display controller of display timing of image data which is to be displayed on a display panel. Conventional display controls may utilize a distinct application processor chip to enhance control of display timing, resulting in increased power consumption and wiring requirements.

### SUMMARY

According to an example embodiment of the inventive concepts, there is provided a timing controller including a timing generation circuit which generates a plurality of timing control signals for controlling display timing of image data that is to be displayed on a flat display panel, in response to a plurality of control signals, and a command generation circuit which analyzes a sensing signal output by at least one sensor and generates a command associated with processing of the image data based on a result of the analysis.

According to an embodiment, the command is a command for selecting a radio frequency (RF) signal associated with the image data from among a plurality of TV RF signals. According to another embodiment, the command is a command for controlling an audio signal associated with the image data. According to another embodiment, when the image data is an electronic program guide (EPG) or a graphic user interface (GUI), the command may be a command for controlling the EPG or the GUI.

According to another example embodiment of the inventive concepts, there is provided a display device including a flat display panel comprising a plurality of signal lines and a plurality of scanning lines, a data driver which drives the plurality of signal lines based on at least one first timing control signal, a gate driver which drives the plurality of scanning lines based on the at least one second timing control signal, a timing controller which generates the at least one first timing control signal and the at least one second timing control signal, which are for controlling display timing of image data that is to be displayed on the flat display panel, in response to a plurality of control signals, and a command generation circuit which analyzes a sensing signal output by at least one sensor and generates a command associated with processing of the image data based on a result of the analysis.

The at least one sensor may be an image sensor, a gyroscope sensor, a geo-magnetic sensor, an accelerometer sensor, a G-sensor, a light sensor, a proximity sensor, or a microphone.

The command generation circuit may be built in one of the timing controller and the data driver.

According to an embodiment, the display device further includes a control circuit which generates a channel tuning signal based on the command, and an RF tuner which selects an RF signal associated with the image data from among a plurality of TV RF signals, based on the channel tuning signal. According to another embodiment, the display device further includes a control circuit which generates an audio control signal based on the command, and an amplifier which controls the volume of a speaker based on the audio control signal.

According to another embodiment, when the image data is an EPG, the display device further includes a control circuit which controls the EPG based on the command. According to another embodiment, when the image data is a GUI, the display device further includes a control circuit which changes the GUI based on the command. The GUI may be a tool bar.

The display device may be a digital TV, a three-dimensional (3D) TV, or a smart TV.

The timing controller and the data driver may be mounted on the same printed circuit board (PCB). When the data driver and the timing controller are mounted on different PCBs, the data driver and the timing controller may be connected to each other via a flexible PCB (FPCB).

According to another example embodiment of the inventive concepts, there is provided a display module chipset including a timing controller which generates a plurality of timing control signals for controlling display timing of image data that is to be displayed on a flat display panel, in response to a plurality of control signals; a data driver which drives a plurality of signal lines included in the flat display panel based on at least one of the plurality of timing control signals and the image data; and a command generation circuit which analyzes a sensing signal output by at least one sensor and generates a command associated with processing of the image data based on a result of the analysis.

The command generation circuit may be implemented by using a separate dedicated chip for command generation. Alternatively, the command generation circuit may be built in one of the timing controller and the data driver.

At least one example embodiment relates to a timing controller.

In one embodiment, the timing controller includes a sensor interface configured to analyze signals provided from sensors and instruct a control circuit to process image data based on the analysis; and a timing generation circuit configured to generate timing signals to drive a display based on the processed image data and control signals from the control circuit.

In one embodiment, the sensor interface is configured to analyze signals instructing the control circuit to vary an image displayed on the display and generate a command instructing the control circuit to process the image data based on the analysis.

In one embodiment, the control circuit is configured to process the image data based on the command provided by the sensor interface and provide the processed image data to the timing generation circuit.

In one embodiment, the sensors are configured to sense inputs provided by a user.

In one embodiment, the timing generation circuit is provided on a same circuit board as the sensor interface configured to analyze the signals provided from the sensors, and the timing generation circuit is configured to provide the timing signals to a source driver and a gate driver.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram of a display device according to an example embodiment of the inventive concepts;

FIG. 2 is a flowchart of an operation of the display device illustrated in FIG. 1, according to an example embodiment of the inventive concepts;

FIG. 3 is a block diagram of a display device according to another example embodiment of the inventive concepts; and

FIG. 4 is a block diagram of a display device according to another example embodiment of the inventive concepts.

### DETAILED DESCRIPTION OF THE EMBODIMENTS

The present inventive concepts now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

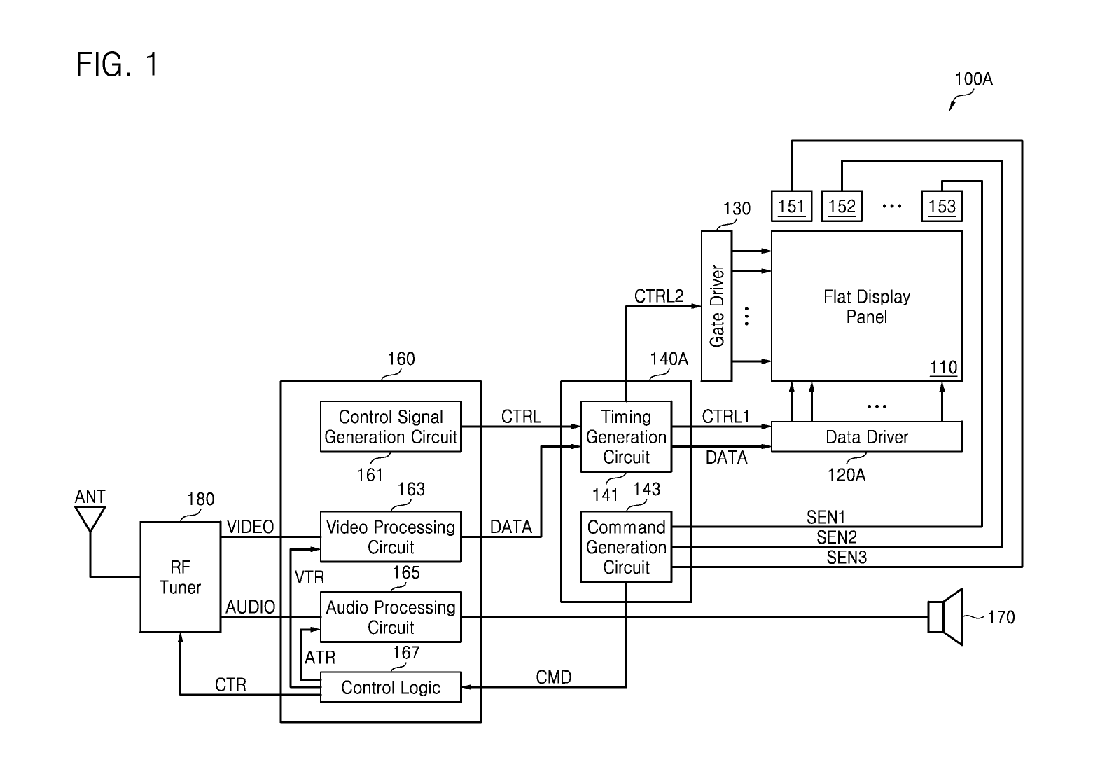

FIG. 1 is a block diagram of a display device according to an example embodiment of the inventive concepts.

Referring to FIG. 1, a display device 100A includes a flat display panel 110, a data driver 120A, a gate driver 130, a timing controller 140A, at least one sensor 151, 152, . . . , 153, a control circuit 160, a speaker 170, and a radio frequency (RF) tuner 180. The data driver 120A and the timing controller 140A constitute a display module chipset.

The display device 100A may be a personal computer (PC), a digital television (DTV), an internet protocol television (IPTV), a smart TV, or a portable electronic device.

The portable electronic device may be implemented by using a laptop computer, a mobile telephone, a smart phone, a tablet PC, a personal digital assistant (PDA), an enterprise digital assistant (EDA), a digital still camera, a digital video camera, a portable multimedia player (PMP), a personal (or portable) navigation device (PND), a handheld game console, an e-book, or a mobile internet device (MID).

The flat display panel 110 may include a plurality of signal lines, a plurality of scan lines, and a plurality of pixels, and may display image data DATA.

The image data DATA may be a still image, a moving picture, a graphic user interface (GUI), an electronic program guide (EPG), or stereoscopic image data.

The flat display panel 110 may be implemented by using a liquid crystal display (LCD) panel, a light emitting diode (LED) display panel, an organic LED (OLED) display panel, an active matrix OLED (AMOLED) display panel, or a flexible display panel.

The data driver 120A may transmit the image data DATA to the signal lines based on at least one first timing control signal CTRL1. In other words, the data driver 120A may drive the signal lines based on the first timing control signal CTRL1 and the image data DATA. The data driver 120A may be referred to as a source driver.

The gate driver 130 may drive the scan lines based on at least one second timing control signal CTRL2. Although the single data driver 120A and the single gate driver 130 are illustrated in FIG. 1 for convenience of explanation, this is only an example.

The timing controller 140A includes a timing generation circuit 141 capable of generating the first timing control signal CTRL1 and the second timing control signal CTRL2 in order to control the timing of the display of the image data DATA on the flat display panel 110, in response to a plurality of control signals CTRL.

The first timing control signal CTRL1 may be a data driver clock signal, a data driver start pulse, and/or a data latch pulse. The second timing control signal CTRL2 may be a gate driver clock signal and/or a gate driver start pulse.

The timing controller 140A may also include a command generation circuit 143, which analyzes sensing signal SEN1, SEN2, . . . , SEN3 output by the at least one sensor 151, 152, . . . , 153, and generates a command CMD associated with processing of the image data DATA based on a result of the analysis.

The command generation circuit 143 may be implemented by using hardware such as a main control unit, or software capable of driving the hardware. The command generation circuit 143 may serve as a sensor interface.

The at least one sensor 151, 152, . . . , 153 is an image sensor, a gyroscope sensor, a geo-magnetic sensor, an accelerometer sensor, a G-sensor, a light sensor, a proximity sensor, or a microphone. For example, the image sensors may sense a gesture of a user to generate a sensing signal. The microphones may sense a voice of a user to generate a sensing signal.

The control circuit 160 includes a control signal generation circuit 161, a video processing circuit 163, an audio processing circuit 165, and a control logic (or a control logic circuit) 167. The control circuit 160 may denote a circuit capable of processing a TV signal (or image data) (e.g., a central processing unit (CPU), a TV engine media processor, or a video/audio processor), an integrated circuit, or a system on chip.

The control signal generation circuit 161 generates a plurality of the control signals CTRL. For example, the control signals CTRL include a vertical synchronization signal, a horizontal synchronization signal, a clock signal, a data enable signal, and the like.

The video processing circuit 163 denotes a circuit that processes a video signal VIDEO and outputs image data DATA corresponding to a result of the processing. The audio processing circuit 165 denotes a circuit that processes an audio signal AUDIO.

The control logic 167 generates at least one of a channel tuning signal CTR, a video control signal VTR, and an audio control signal ATR, based on the command CMD output by the command generation circuit 143.

The RF tuner 180 may select an RF signal associated with the image data DATA from among a plurality of RF signals received via an antenna ANT, based on the channel tuning signal CTR. For example, the channel tuning signal CTR may be used as a selection signal capable of selecting the image data DATA that is to be displayed on the flat display panel 110. The RF tuner 180 may process the selected RF signal and generate the video signal VIDEO and/or the audio signal AUDIO according to a result of the processing.

Based on the video control signal VTR, the video processing circuit 163 may generate the image data DATA. For example, when the image data DATA is an electronic program guide EPG, the video processing circuit 163 may search for or select a TV program included in the EPG, based on the video control signal VTR.

As another example, when the image data DATA is a graphic user interface GUI, the video processing circuit 163 may change the GUI, which is to be displayed on the flat display panel 110, based on the video control signal VTR. The GUI may be a tool bar.

The audio processing circuit 165 may control the volume of the speaker 170 in response to the audio control signal ATR. In this case, an amplifier capable of controlling the volume of the speaker 170 in response to the audio control signal ATR may be installed within or outside the control circuit 160, for example, the audio processing circuit 165.

As described above, the command generation circuit 143, which is built in or integrated into the timing controller 140A, may perform a function that is the same as or similar to the function of a circuit that analyzes a signal output by a TV remote controller and generates a command capable of controlling a video and/or an audio of a TV according to a result of the analysis.

According to an embodiment, the data driver 120A and the timing controller 140A may be mounted on the same printed circuit board (PCB).According to another embodiment, when the data driver 120A and the timing controller 140A are mounted on different PCBs, the data driver 120A and the timing controller 140A may be connected to each other via a flexible PCB (FPCB).

As a routing length between at least one sensor 151, 152, . . . , 153 and the command generation circuit 143 decreases, the command generation circuit 143 may accurately sense the sensing signal SEN1, SEN2, . . . , SEN3 output by the at least one sensor 151, 152, . . . , 153.

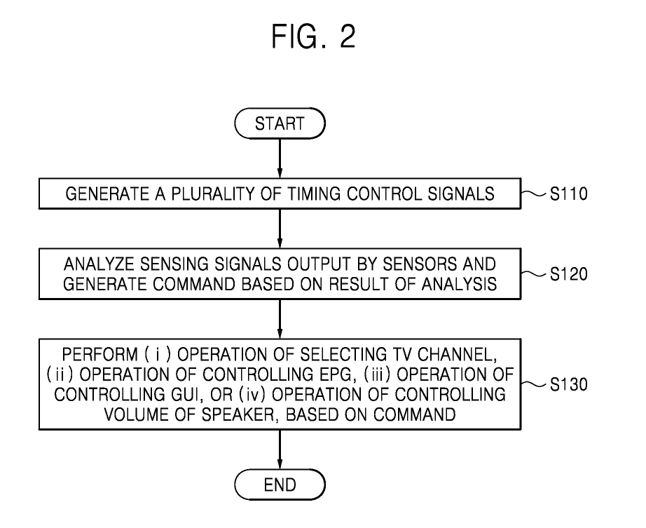

FIG. 2 is a flowchart of an operation of the display device of FIG. 1, according to an example embodiment of the inventive concepts.

Referring to FIGS. 1 and 2, in operation S110, the timing generation circuit 141 generates a plurality of timing control signals in response to the control signals CTRL. The plurality of timing control signals may include the first and second timing control signals CTRL1 and CTRL2 which control timing of displaying the image data DATA on the flat display panel 110.

In operation S120, the command generation circuit 143 analyzes the sensing signal SEN1, SEN2, . . . , SEN3 output by at least one sensor 151, 152, . . . , 153, and generates the command CMD associated with processing of the image data DATA based on a result of the analysis.

In operation S130, based on the command CMD, the control circuit 167 may generate at least one of a channel tuning signal CTR for an operation (i) of selecting a TV channel, a video control signal VTR for an operation (ii) of searching for or selecting a desired program from an EPG displayed on the flat display panel 110, a video control signal VTR for an operation (iii) of controlling a GUI which is displayed or is to be displayed on the flat display panel 110, and an audio control signal ATR for an operation (iv) of controlling the volume of the speaker 170.

The channel tuning signal CTR, the video control signal VTR for the operation (ii), the video control signal VTR for the operation (iii), and the audio control signal ATR correspond to the image data DATA which is to be displayed on the flat display panel 110.

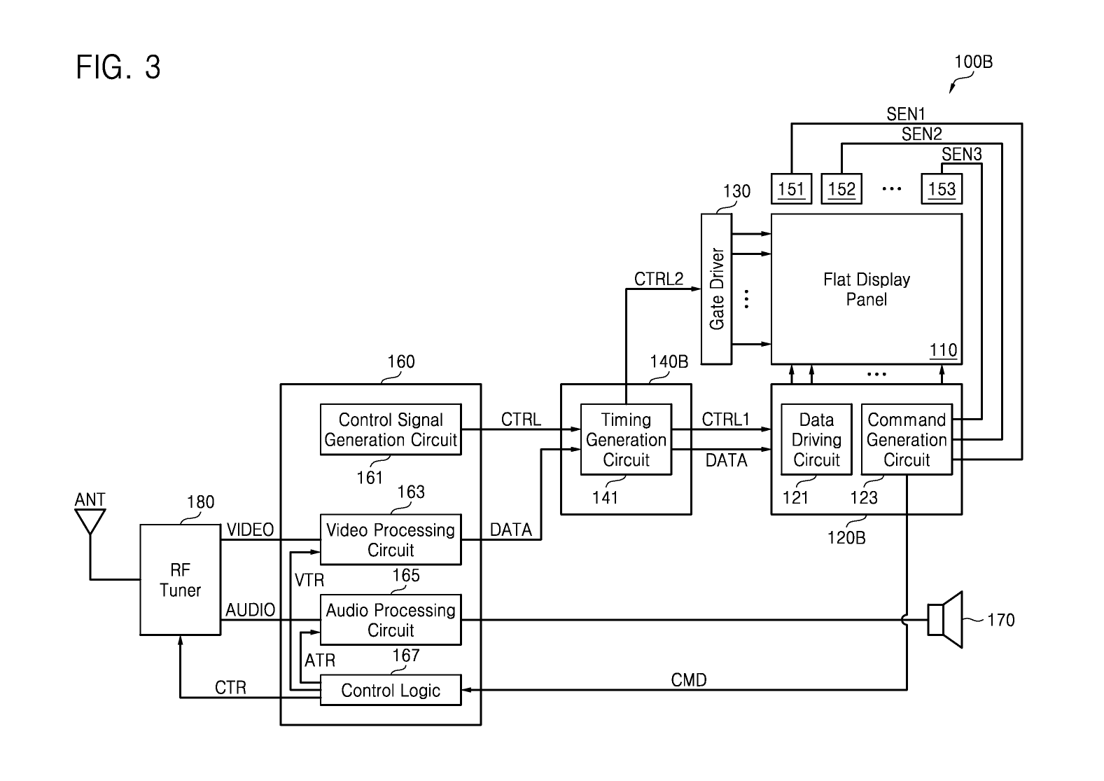

FIG. 3 is a block diagram of a display device according to another example embodiment of the inventive concepts.

A structure and an operation of the display device 100B of FIG. 3 are substantially the same as those of the display device 100A of FIG. 1, except for a timing controller 140B and a data driver 120B which constitute a display module chipset. In the example embodiment illustrated in FIG. 3, a command generation circuit 123 is installed within or integrated into the data driver 120B, the timing controller 140B includes a timing control circuit 141. The data driver 120B also includes a data driving circuit 121 which drives a plurality of signal lines based on at least one control signal CTRL1 and image data DATA.

As described above, the data driver 120B and the timing controller 140B may be mounted on the same PCB or on different PCBs. In other words, the command generation circuit 123 analyzes the sensing signal SENT, SEN2, . . . , SEN3 output by at least one sensor 151, 152, . . . , 153, generates the command CMD associated with processing of the image data DATA based on a result of the analysis, and outputs the command CMD to the control logic 167.

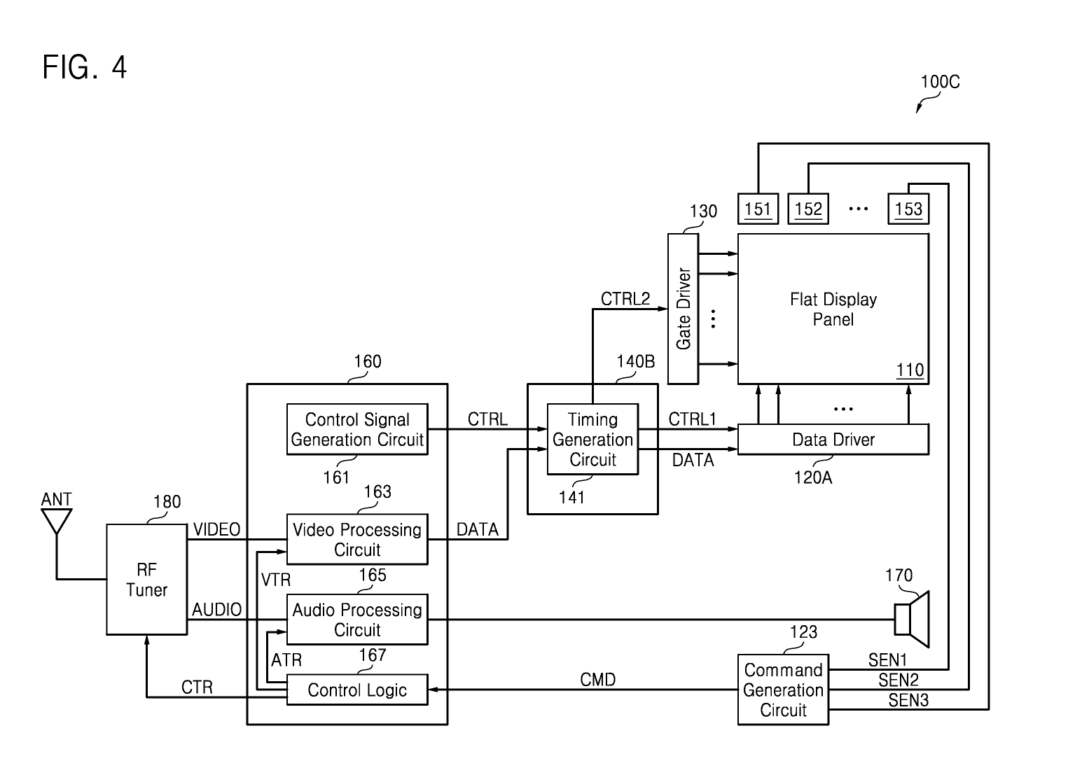

FIG. 4 is a block diagram of a display device according to another example embodiment of the inventive concepts.

Referring to FIGS. 1 and 4, a structure and an operation of a display device 100C of FIG. 4 are substantially the same as those of the display device 100A of FIG. 1, except for a timing controller 140B and a command generation circuit 123. The data driver 120A, the timing controller 140B, and the command generation circuit 123 constitute a display module chipset. The command generation circuit 123 may be a special circuit or a separate dedicated chip. For example, at least two of the data driver 120A, the timing controller 140B, and the command generation circuit 123 may be mounted on the same PCB. When the data driver 120A, the timing controller 140B, and the command generation circuit 123 are mounted on different PCBs, the PCBs may be connected to one another via an FPCB.

As described above with reference to FIGS. 1 through 4, the display device 100A, 100B, or 100C including the command generation circuit 123 or 143 may generate the command CMD for processing the image data DATA and/or an audio signal associated with the image data DATA, based on the sensing signal SENT, SEN2, . . . , SEN3 output by at least one sensor 151, 152, . . . , 153 without a special application processor chip, and may generate the channel tuning signal CTR, the video control signal VTR, or the audio control signal ATR based on the command CMD.

The command generation circuit 143 or 123, which is capable of performing a function of a sensor interface, may be built in the timing controller 140A as illustrated in FIG. 1 or in the data driver 120B as illustrated in FIG. 3, or may be implemented by using a separate dedicated chip for command generation as illustrated in FIG. 4. The separate dedicated chip for command generation is different from the application processor chip.

A display module chipset including a sensor interface according to the example embodiments of the inventive concepts may interpret a sensing signal output by at least one sensor and generate a command associated with processing of image data based on a result of the interpretation. Therefore, a display device including the display module chipset may reinforce user experience according to the command without needing to include a special application processor chip.

While the inventive concepts have been particularly shown and described with reference to example embodiments thereof, it will be understood that various changes in form and details may be made therein without departing from the spirit and scope of the following claims.

What is claimed is:

1. A timing controller comprising:
a timing generation circuit configured to generate a plurality of timing control signals to control timing of image data displayed on a flat display panel, in response to a plurality of control signals; and
a command generation circuit configured to analyze a sensing signal output by at least one sensor and generate a command associated with processing the image data based on a result of the analysis.

2. The timing controller of claim 1, wherein the command selects a radio frequency (RF) signal associated with the image data from among a plurality of RF signals.

3. The timing controller of claim 1, wherein the command controls an audio signal associated with the image data.

4. The timing controller of claim 1, wherein, when the image data is an electronic program guide (EPG) or a graphic user interface (GUI), the command is a command for controlling the EPG or the GUI, respectively.

5. A display device comprising:
a flat display panel including a plurality of signal lines and a plurality of scanning lines;
a data driver configured to drive the plurality of signal lines at timing determined based on at least one first timing control signal;
a gate driver configured to drive the plurality of scanning lines at timing determined based on at least one second timing control signal;
a timing controller configured to generate the at least one first timing control signal and the at least one second timing control signal in response to a plurality of control signals; and
a command generation circuit configured to analyze a sensing signal output by at least one sensor and generate a command associated with processing of the image data based on a result of the analysis.

6. The display device of claim 5, wherein the at least one sensor is one or more of an image sensor, a gyroscope sensor, a geo-magnetic sensor, an accelerometer sensor, a G-sensor, a light sensor, a proximity sensor, and a microphone.

7. The display device of claim 5, wherein the command generation circuit is built in one of the timing controller and the data driver.

8. The display device of claim 5, further comprising:
a control circuit configured to generate a channel tuning signal based on the command; and
an RF tuner configured to select an RF signal associated with the image data from among a plurality of RF signals, based on the channel tuning signal.

9. The display device of claim 5, further comprising:
a control circuit configured to generate an audio control signal based on the command; and
an amplifier configured to control a volume of a speaker based on the audio control signal.

10. The display device of claim 5, when the image data is an electronic program guide EPG, the display device further comprises:
a control circuit configured to control the EPG based on the command.

11. The display device of claim 5, when the image data is a graphical user interface GUI, the display device further comprises:
a control circuit configured to change the GUI based on the command.

12. The display device of claim 11, wherein the GUI comprises a tool bar.

13. The display device of claim 5, wherein the display device is one of a digital TV, a three-dimensional (3D) TV, and a smart TV.

14. The display device of claim 5, wherein the timing controller and the data driver are mounted on the same printed circuit board (PCB).

15. The display device of claim 5, wherein, when the data driver and the timing controller are mounted on different PCBs, the data driver and the timing controller are connected to each other via a flexible PCB (FPCB).

16. A timing controller comprising:
a sensor interface configured to analyze signals provided from sensors and instruct a control circuit to process image data based on the analysis; and
a timing generation circuit configured to generate timing signals to drive a display based on the processed image data and control signals from the control circuit.

17. The timing control of claim 16, wherein the sensor interface is configured to analyze signals instructing the control circuit to vary an image displayed on the display and generate a command instructing the control circuit to process the image data based on the analysis.

18. The timing controller of claim 16, wherein the control circuit is configured to process the image data based on the command provided by the sensor interface and provide the processed image data to the timing generation circuit.

19. The timing controller of claim 16, wherein the sensors are configured to sense inputs provided by a user.

20. The timing controller of claim 16, wherein the timing generation circuit is provided on a same circuit board as the sensor interface configured to analyze the signals provided from the sensors, and the timing generation circuit is configured to provide the timing signals to a source driver and a gate driver.
